(19) United States
(12) Patent Application Publication
(10) Pub. No.: US 2020/0260532 A1
(43) Pub. Date: Aug. 13, 2020

(54) PERFORATED LAMINAR HEATING ELEMENT

(71) Applicant: LaminaHeat Holding Ltd., Leixlip, Co. Kildare (IE)

(72) Inventor: Peter J. Sajic, County Kildare (IE)

(73) Assignee: LaminaHeat Holding Ltd., Leixlip, Co. Kildare (IE)

(21) Appl. No.: 16/784,715

(22) Filed: Feb. 7, 2020

Related U.S. Application Data
(60) Provisional application No. 62/803,184, filed on Feb. 8, 2019.
(60) Provisional application No. 62/929,460, filed on Nov. 1, 2019.

(51) Int. Cl. H05B 3/34; H05B 3/00; H05B 3/14; H05B 3/03

(52) U.S. Cl. CPC H05B 3/342; H05B 3/0004; H05B 2203/015; H05B 3/03; H05B 2203/007; H05B 3/145

(57) ABSTRACT

A laminar heater with an electrically conductive laminar heating element having a pair of electrically conductive busbars disposed adjacent opposite ends of the heating element and at least a first area having a plurality of perforations with a generally polygonal geometry. Embodiments include those with Y-shaped perforations, including some with one prong diverging into a bulbous, optionally diamond-shaped, end, and those defined by an array of generally diamond shaped perforations intermeshed with an array of circular shaped perforations. Processes of manufacture and installation, heating systems including such heaters, and multi-ply embodiments having non-metal plies and an outer metal surface layer, are also disclosed.

### CROSS REFERENCE TO RELATED APPLICATIONS

This application claims priority from U.S. Provisional Application Ser. No. 62/803,184, filed Feb. 8, 2019, and from U.S. Provisional Application Ser. No. 62/929.460, filed Nov. 1, 2019, both titled 3D FLEXIBLE LAMINAR HEATING ELEMENT, and incorporated herein by reference.

### BACKGROUND OF THE INVENTION

Laminar heating elements with various perforation patterns are described in U.S. application Ser. No. 15/928,952, filed 22 Mar. 2018, incorporated by reference herein in its entirety. In one embodiment discussed in detail in the '952 Application, the perforations comprise slits, as shown herein in FIG. 3. There remains a need in the art for irregularly shaped flat heaters and methods for making them that provide uniform heat up and distribution and/or flat heaters with a heat distribution that can is be readily customized or tailored to suit a particular purpose, as well as flat heaters that can be conformed into 3D shapes with a relatively high degree of flexibility.

### BRIEF DESCRIPTION OF THE DRAWINGS

FIG. 1 illustrates an exemplary heating element having an exemplary perforation pattern.

FIG. 2 is a close up illustration of the exemplary perforation pattern depicted in FIG. 1, and further disclosed in U.S. Design Patent Application Ser. No. 29/679,731, incorporated herein by reference.

FIG. 3 illustrates an exemplary perforation pattern as depicted in U.S. application Ser. No. 15/928,952.

FIG. 4 illustrates an exemplary slit perforation pattern as depicted in U.S. Design Patent Application Ser. No. 29/709,098, incorporated herein by reference.

FIG. 5A illustrates a close up of a selected group of perforations of the pattern illustrated in FIG. 4.

FIG. 5B illustrate a close up of a single perforation of the pattern illustrated in FIG. 4.

FIG. 6 illustrates an exemplary heating element having the exemplary perforation pattern illustrated in FIG. 4.

FIG. 7A illustrates a portion of an exemplary heating element perforation pattern having perforations in the shape of a diamond.

FIG. 7B highlights a grouping of adjacent perforations of the pattern depicted in FIG. 7A.

FIG. 8 illustrates an exemplary heating element perforation pattern having perforations generally in the shape of a square.

is FIG. 9A illustrates a portion of an exemplary heating element comprising, a plurality of units, each with a perforation pattern comprising a combination of geometric shapes.

FIG. 9B illustrates a magnified area of the exemplary heating element of FIG. 9A.

FIG. 9C illustrates another magnified area of the exemplary heating element of FIG. 9A.

FIG. 9C illustrates another magnified area of the exemplary heating element of FIG. 9A.

FIG. 9D illustrates one of the heating element units of the exemplary heating element of FIG. 9A.

FIG. 10 illustrates a cross section of an exemplary heating element composite having a grounding layer.

### DETAILED DESCRIPTION OF THE INVENTION

Exemplary heaters that may particularly benefit from various aspects of the s invention as claimed and described herein may include non-metallic conductive film heaters such as LaminaHeat® PowerFilm™ or PowerFabric™ heaters, produced by LaminaHeat of Greenville, S.C. PCT Published Application No. WO 2016/113633 (“the '633 WO Publication), which claims priority from U.S. Provisional Patent Application Ser. No. 62/102,169, both of which are incorporated herein by reference in their entireties, provide a detailed disclosure of exemplary heater embodiments, the core which is referred to as an illustrative example herein, without limitation. Embodiments of the invention may include any construction, or functional portion thereof, disclosed in the '633 WO Publication to which the teachings of this invention are implemented. As disclosed therein, a preferred construction for the core heater element may comprise an electrically conductive, wet-laid, non-woven fiber layer comprising a plurality of individual unentangled fibers, comprising conductive (e.g. carbon) fibers or a combination of conductive fibers and non-conductive (e.g. glass) fibers, wherein the plurality of unentangled fibers collectively has an average length of less than 12 mm. At least two conductive strips electrically are connected to the fiber layer over a predetermined length, positioned adjacent opposite ends of the fiber layer, and configured to be electrically connected to a power source. The fiber layer includes a plurality of perforations that increases the electrical resistance in a perforated portion Of the fiber layer relative to resistance in the absence of perforations. In some embodiments, the plurality of perforations in the fiber layer may define a pattern that extends through the conductive strips. It should be understood that the core heater elements described herein may be used in conjunction with any number of other coatings, plies or layers, such as but not limited to those described in the '633 WO Publication, Thus, an exemplary heater may comprise a plurality of layers.

### Modification of Resistance Using Different Open Area Percentages

The laminar heaters as described herein are essentially two-dimensional system n which the thin films of the laminar heaters may be considered as two-dimensional entities for purposes of defining resistance. Current flows between opposing busbars. The term “resistance” refers to resistance to current flow along the plane of the sheet, not perpendicular to it. In a regular three-dimensional conductor, the resistance can be written as: Resistance=pL/A where p is the resistivity, A is the s cross-sectional area and L is the length. For a laminar heating element as described herein, the cross-sectional area A is a multiple of the width of the sheet W and the sheet thickness t Thus Resistance=W('t). Combining the resistivity with the thickness yields: Resistance=(p/t)(L/W)=Rs(L/W), where Rs=p/t. Thus, we refer to Rs as the resistance of the laminar heating element. If the film thickness is known, in the bulk resistivity (in ω cm) can be calculated by multiplying the sheet resistance Rs by the film thickness t in cm.

Resistance for the laminar heaters described herein embody a special case of resistivity for a uniform film thickness. Commonly, resistivity (also known as bulk resistance, specific electrical resistance, or volume resistivity) is in units of ω·m, which as is more completely stated in units of ω·m2/m (ω·area/length). Dividing by the sheet thickness (in m) causes the m units to cancel, and represents a special “square” situation yielding an answer in ohms ω.

An alternative, common unit is “ohms per square” (denoted “ω/sq”), which is dimensionally equal to an ohm, but is exclusively used for resistance of laminar heating elements, such as those described herein. The reason for the name “ohms per square” is that a square laminar heater with resistance 10 ohm/square has an actual resistance of 10 ohm, regardless of the size of the square, (For a square, L=W, so Rs=R) The unit can be thought of as, loosely, “ohms×aspect ratio.”

Example: A 3-unit long (L=3) by 1-unit wide (W=1) (i.e. aspect ratio=laminar heating element having a resistance of 21 Ω/sq would have a total resistance of 63 Ω (because it is composed of three 1-unit by 1-unit squares). This is the resistance that would be measured if the 1-unit edges were attached to an ohmmeter that made contact entirely over each edge,

An aspect of the invention comprises a process for customizing the resistance of a laminar heating element. The laminar heating element is perforated with different hole patterns to give resulting different electrical resistance values. This process permits customizing a generic laminar heating element material to provide variable resistance capability. This technology also allows a laminar heating element to be designed with a variable resistance, thereby giving different heating zones within a continuous laminar heating element material itself. Laminar heating elements may s thus be designed to easily give a range of electrical resistance values, and thus a range of power outputs from the same material. The subject technology also permits design of laminar heating elements having a non-rectangular shape with uniform (or otherwise carefully designed) heat output over the entire non-rectangular shape.

As a general rule, electrical resistance is related to the open area percentage produced by a perforation pattern. The open area can be varied by using different perforation patterns.

The film may be perforated using any means known in the art, but a preferred embodiment employs a stamping press and die process. Perforation processes employing lasers may also be used. Although not limited to any particular type of is machine or technology, perforation equipment configurable to provide controlled variation in perforation spacing, size, etc., such as via computer control, are ideal. The holes are preferably punched cleanly such that no conducting fibers protrude into the hole area. The perforation spacing and size may be tailored to achieve a desired uniformity of heat distribution in the heating element. Uniformity is typically defined by industry standards relevant to a particular application, but as a non-limiting example, some standards may require uniformity in a range of ±5-7% temperature variation over the area of a particular segment of the heating element.

The perforating step may be performed prior to a step of disposing the heating film within upper and lower insulating layers, or after such disposition. In the latter case, the perforations extend through the non-metallic heating element and the outer insulating layers. In the former case, wherein the upper and lower insulating layers comprise an insulating coating, including an insulating adhesive (such as an adhesive for adhering outer insulating fiber layers to an inner carbon veil core, for example), the insulating coating may fill or partially fill some or all of the perforations. Thus, the resulting heating element may comprise a core, such as a carbon veil, having conductive busbars, having a collective upper surface that is covered by an upper insulating coating and a collective lower surface that is covered by a lower insulating coating, wherein perforations are filled or partially filled with the insulating coating material. The filling may comprise a continuous filling, a filling with a discrete boundary (not shown), or a filling with an air gap between partial fillings that extend from each of top and bottom coating layers, in an alternate embodiment, the resulting heating element may comprise core, upper and lower insulating coatings, and perforations that extend through the core and the insulating coatings. The perforations may also extend through conductive busbars.

Laminar heating elements having different power outputs in different sections of the heater may be created using different perforation patterns in different sections. As used herein the term “different perforation patterns” may refer to any difference between one section relative to another that causes a difference in open area. For example, and without limitation, these differences may comprise differences in perforation geometry, spacing, and arrangement or packing relative to one another, or a combination thereof. Applying a voltage to a heater so created creates different heating zones with different amounts of heat generation per area within the same material. This may be of particular interest, for example, in mold tool heating in which an even heat up is desirable for molded parts having sections with different thicknesses.

Exemplary laminar heating elements may have a non-rectangular shape with an approximately uniform heat-up rate along the entire area of the non-rectangular shape. Modifying the perforation pattern or perforation characteristics permits customizing or tuning the resistance in heaters, which may be particularly useful for heaters having non-rectangular or otherwise non-uniform shapes by applying varying perforation patterns in different sections of a heater.

Thus, the resistance of a laminar heating element, or portions thereof, may be modified without changing its underlying material properties, by perforating the laminar heating element with a perforation pattern, which process may be employed to give different electrical resistance values in different areas of the sheet by using different perforation patterns in the different areas. This allows a generic heater material to be used with a variable resistance capability, and allows a laminar heater to be designed with a variable resistance across the continuous surface of the heater, thereby providing different heating zones within the heater material itself. Although the technology permits providing a continuous laminar heating element with different perforation patterns in different areas, it should be understood that in constructions comprising different discrete sheets of the same material with different perforation patterns can also be placed adjacent to one another, and optionally connected to one another, such as with stitching, adhesive tape, or the like, without limitation. Applying varying perforation patterns also permits creation of laminar heating elements with non-rectangular or non-uniform, shapes.

Although, described herein with respect to a specific exemplary laminar heating element, the process is not limited to any particular materials of construction. The process may be employed to tune or otherwise customize resistance of any laminar heating element or portion thereof having any materials of construction that are safely functional after perforation, and characterized by a resistance that varies with the open area percentage introduced by such perforations.

Although certain perforation “packing patterns are described and/or depicted” herein, it should be understood that the invention is not limited to any particular perforation packing patterns.

It should also be understood that some, areas of the heater may have no perforations, and thus may have a zero open area percentage in that area. Thus, exemplary heaters may comprise one or more areas having a zero open area percentage disposed adjacent an area having a non-zero open area percentage, or areas adjacent one another with different open areas may both have non-zero open area percentages.

Furthermore, the heater may comprise a first discrete area having a first pattern throughout the first area and a second discrete area having a second pattern throughout the second area that is different than the pattern in the first area, in which the first and second areas are separated by a gradient area comprising a gradual change from the first pattern to the second pattern within the gradient area. In other embodiments, each adjacent area may lie adjacent one another on a continuous sheet with no gradient section or other separation therebetween.

Finally, it should also be understood that a single sheet may have one, two, or more than two patterns of holes or absence of holes in different portions of the sheet, to tailor the overall resistance in any manner desired. Furthermore, a system comprising multiple sheets may comprise a plurality of identical sheets or any number of different sheet types in which at least one sheet has a different property than at least one adjacent sheet.

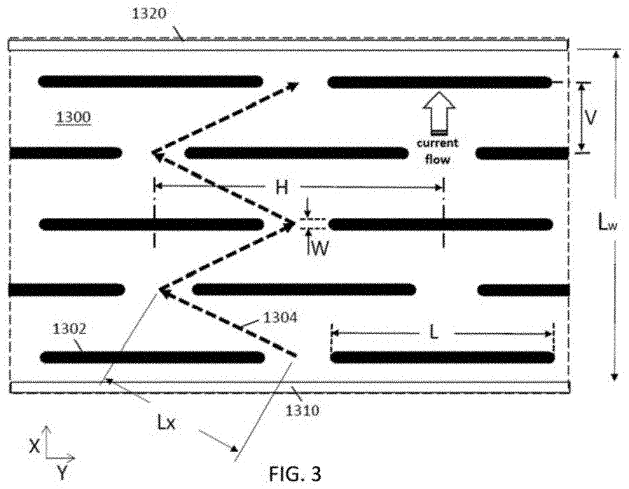

Although depicted with regular packing patterns, the invention is not limited to regular patterns. Although illustrated herein using a specific geometry, it should be understood that perforations of any geometry may be employed, without limitation, particularly any shapes can be cleanly formed using any technology for forming perforations known in the art. One exemplary embodiment using non-round perforations as shown and described in U.S. application Ser. No. 15/928,952 is depicted in FIG. 3 and explained in more detail herein below,

FIG. 3 depicts an exemplary sheet 1300 having a 45-degree staggered perforation pattern, in which each perforation 1302 is non-round in the shape of a slit, Each slit in the exemplary embodiment depicted has a length of L and a width of W, and adjacent slits in the same row are spaced a distance H on center, and adjacent rows are spaced a distance V on center. The formula for calculating the open area for such a configuration can be expressed as Equation 4:

$$\frac{( W \times L - 0.215 {W}^{2} ) \times 100}{0.5 \times V \times H} \qquad ( 4 )$$

A slit perforation design not only permits tailoring of the open space, but also permits tailoring of the developed path length 1304 that the electrons have to travel between the bus bars. This tailoring of path length enables tailoring of the electrical resistance of one portion of a heater relative to another while maintaining the same or similar open area in both portions. Maintaining the same or similar open area promotes uniformity in heating. A slot or slit pattern alters the flow path of the electrons more drastically/efficiently than a pattern of round perforations. The formula for calculating the path length Lx for a 45 degree offset slit configuration can be expressed as Equation 5:

$$L x = \frac{0.5 VH * sqrt ( {V}^{2} + {L}^{2} \text{/} 4 )}{1 - ( WL - 0.215 {W}^{2} )} \qquad ( 5 )$$

wherein sqrt(V²+L²/4) is the contribution to the path length from the geometric vector, and the remaining portion of the equation is the contribution to the path length from the open area. It should be understood that the overall path length from busbar 1310 to busbar 1320 approximately equals (Lx)(# of rows of slits), plus the distance from each busbar to the nearest row, which dimension has a negligible impact over a to long sheet. Thus, for a heating element having a length Lw between busbars with N rows of slit-shaped perforations, the resistance is proportional to N*Lx. The increase in resistance over the length Lw created by adding perforations relative to an otherwise identical unperforated heating element is generally proportional to N*Lx/Lw.

as The term “slit” as used herein refers to a perforation that has a length dimension L that is longer than the width dimension W, in which the ratio L:W is at least greater than 2 and preferably greater than 10 and more preferably in a range of 10 to 200. The L direction is preferably disposed generally perpendicular to the flow path of the electricity through the heater element (e.g. the path between the positive and negative busbars), so that the electrons must go around the length dimension of the slit to continue travel in the flow path, such as in the path 1304 depicted in FIG. 3.

In additional creating variations in resistance in one section relative to another using variations in L and W of the slits or spacing H between adjacent slits H and spacing V between adjacent rows, variation in resistance can also be varied by modifying the angle of the slits relative to the busbars. Although the slits may be parallel to one or both of the busbars (i.e. generally perpendicular to the flow path of the electrons between the busbars), the slits may also be positioned at an oblique angle relative to the busbars, thus changing the flow path for slits at a given angle relative to slits parallel to the busbar(s). Variations in angle of the L dimension relative to the busbar thus provides an additional parameter by which the resistance can be varied. Notably, perforations comprising slits as described herein provide for a greater range of resistance values relative to round shapes. In fact, the roughly rectangular shape of the slit permits variation in both W and L, which provides an ability to modify the resistance up to a factor of 30 based on hole geometry, whereas the changes in resistance for a round hole geometry only permits modification up to a factor of 5.

The slits may be created by any method known in the art, including laser cutting, routing, etching, or the like. Slit sizes and spacing may be varied to create variable resistance in accordance with all of the various embodiments described herein.

It should be understood that use of non-round perforations, and specifically slit-type perforations, more specifically a 45-degree staggered slit perforation pattern as disclosed herein, are not limited to the embodiments having variable resistance across a given area or having non-parallel busbars, as described herein. For example, non-round perforations, specifically slit-type perforations, and more specifically a 45-degree staggered slit perforation pattern, or any of the perforation patterns described herein, may be implemented in any laminar heater or heater element having the features described in U.S. application Ser. No. 15/542,884 (the national phase application of the '633 WO Publication), owned by the Applicant of this Application, and incorporated herein by reference in its entirety. Laminar heaters and heater elements having non-round perforations, specifically slit-type perforations, and more specifically a 45-degree staggered slit perforation patterns, or any of the perforation patterns described herein, may also be used in products and busbar assemblies described in PCT Application Ser. No. PCT/IB2017/000870 (published as WO2017/216631) and U.S. Provisional Application Ser. No. 621579,472, both of which are owned by the Applicant of this Application and which are hereby incorporated by reference in their entireties.

It should further be understood that just as open area percentage may be tailored to create a customized resistance, as described above, any perforation characteristic (e.g. geometry, spacing, perforation pattern, number of perforations per unit area, perforation size, open area percentage, path length, presence of absence of perforations at all, etc.) or any combination of perforation characteristics may be selected to give customized resistance in one area of a heating element relative to another. In particular, a combination of path length and open area percentage may together be tailored to provide an area of the heating element having desired heating characteristics. The perforation characteristics may be tailored to vary the electrical resistance in the material in both X and Y directions.

Although some exemplary hole sizes and spacing have been described herein, it should be understood that the sizes and spacing of the holes for a particular material may be limited to a range that collectively provides less than a threshold amount of current density in the non-open areas and less than a threshold amount of current density variation between areas directly bordering holes and areas not bordering the holes, which may also be dependent upon the smallest distances remaining between open areas. Different materials may thus be characterized using methods known in the art for ensuring operation for a specific application within predetermined specifications.

The hole patterns thus created as described herein may be specified by a computer processor programmed with instructions for specifying the hole diameter, spacing, and packing pattern corresponding to the percentage open area needed to is create a user-specified level of heat output for the subject heating material having a bulbar configuration as specified by a user of such a computer. The various equations, look up tables, and the like may be programmed into the computer processor, and the computer processor may provide an output to a computer assisted manufacturing process to automatically create the perforations corresponding to the specifications generated by the computer. Thus, a user may be able to define a shape having specified dimensions for use with a specified heating element with well-characterized materials of construction and a pre-determined tolerance for variation in current density across the heating element, and the computer program may a automatically specify the hole pattern, diameters, and spacing across the entire dimension of the shape to achieve the desired heat output within the pre-determined tolerances. In particular, the computer processor may be well suited for creating subtle variations in hole diameter, spacing, and spacing angles within desired ranges to create a smooth gradient in overall current density and heat output between a first end of a sheet to another, such as from the leftmost side to the rightmost side of heating element 500. Thus, some exemplary embodiments may have no perceivable step change between one portion of the perforation pattern to another. The techniques for programming a computer to perform such a task are known in the art. In particular, techniques analogous to those utilized in the printing industry, in which dots of different sizes (AM screening), frequency (FM screening), or a combination, thereof (hybrid AM/FM screening) are used over the course of a printed image to define areas that receive more or less ink, may be used for disposing perforations in a gradient in which the open area (analogous to ink deposition in printing) changes smoothly from one region to another to provide even resistance over the course of an irregularly shaped heating element in which opposite busbars are not parallel.

Segmented Heaters Having Segments with Different Open Areas

It should be understood that the methods and structures for providing variability ire resistance and heat output using perforation patterns as described herein may be combined with segmented design shown and described in U.S. Ser. No. 15/928,952.

### Manufacturing Processes

Although not limited to any particular method of manufacture, an exemplary is process for making a laminar heater may include the processes as described in U.S. application Ser. No. 15/928,952.

### 3D Flexible Embodiments

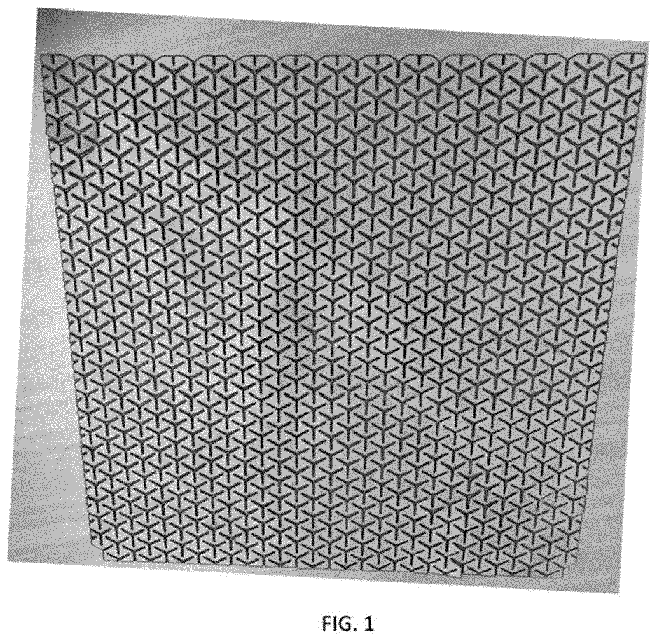

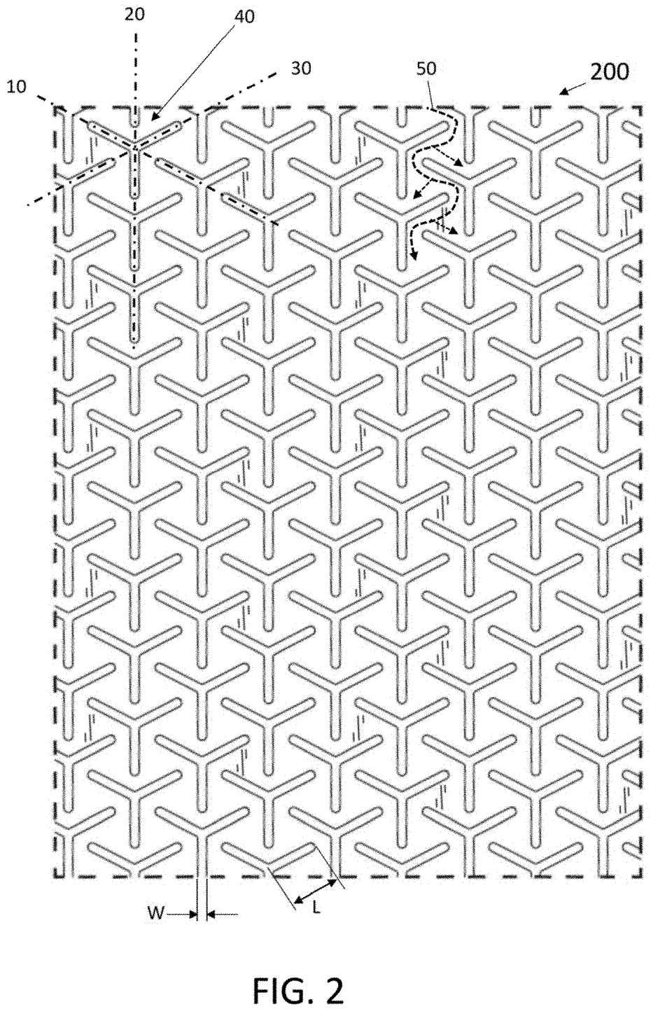

As depicted in FIGS. 1-2, and as depicted in U.S. Design Patent Application Ser. No. 29/679,731, filed Feb. 8, 2019, incorporated herein by reference, heater embodiments may also be provided with a perforation geometry that is particularly well-suited for shaping into 3 dimensional shapes, such as for use in clothing, seats, beds, medical devices, and the like, without limitation.

As depicted in FIGS. 1 and 2, each perforation comprises a Y-shaped slit when the laminar heater or heating element is at rest in a planar configuration. More generally, each perforation can be described as having a geometry comprising a plurality of rectangular slit shaped prongs extending along three co-planar axes 10, 20, 30 from an intersection point 40 of the axes. Although depicted with three axes, more than three axes may be provided. In the shape depicted in FIGS. 1 and 2, the axes are oblique to one another and form a Y-shape with equal angles (120 degrees) between adjacent prongs. Such a perforation geometry permits the laminar heating element to be conformable from a planar geometry to a 3D shape within a predetermined (relatively high) degree of flexibility, which is a considerably greater range of flexibility than is provided by a perforation pattern comprised of slits aligned along a set of parallel axes, as depicted in FIG. 3. A geometry comprising 3 or more prongs emanating from a common intersection, in which each prong has a L and W, in which the ratio of L:W is greater than 2, and more preferably between 2 and 10, provides relatively greater flexibility for bending the laminar sheet into non-planar shapes than is provided by an aligned slit design, while also providing the advantages of a slit design over a round hole design with respect to the ability to customize resistance. Variables that permit customizing of resistance include the length and number of the prongs, the width of the prongs, the orientation of the prongs relative to the busbars, and the packing of the perforations relative to one another. As depicted, the prongs of the Y-shaped perforations are nested such that the electron is flow around the Y shapes has a path 50 that is serpentine in configuration, with changes of direction of more than 90 degrees at various points. While depicted with 3 prongs, it should be understood that designs having 4 or more prongs may be provided.

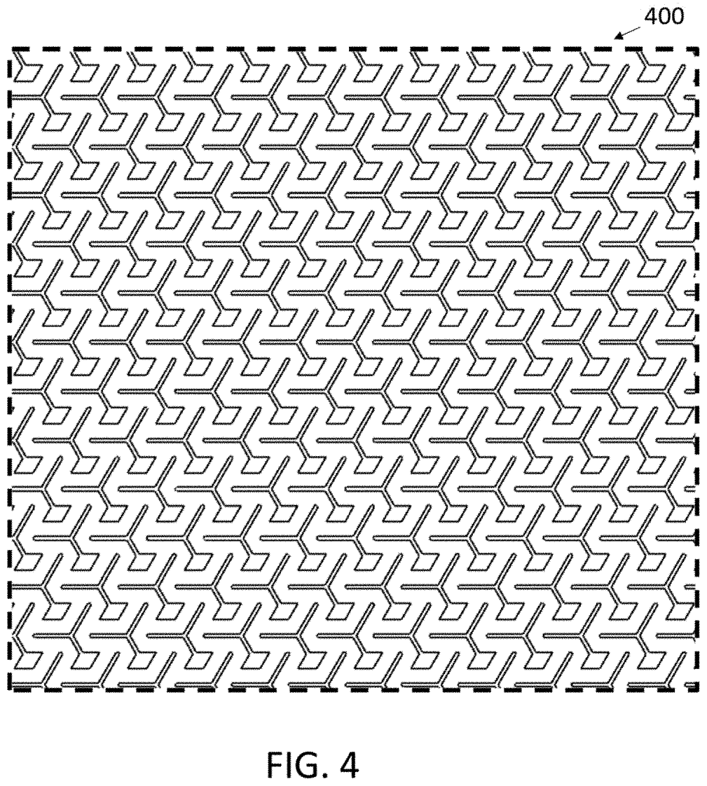

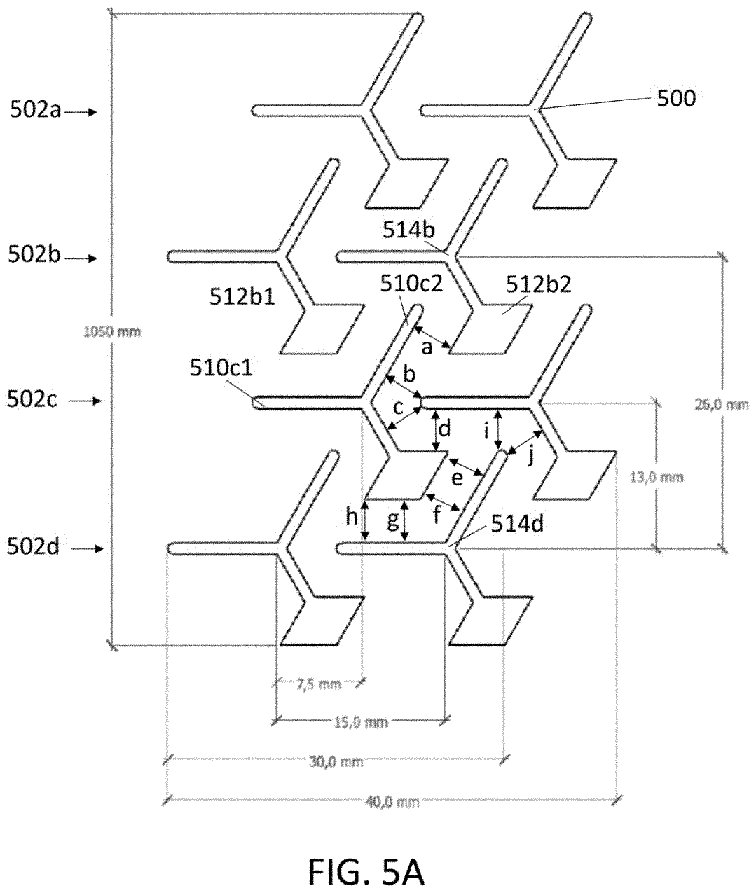

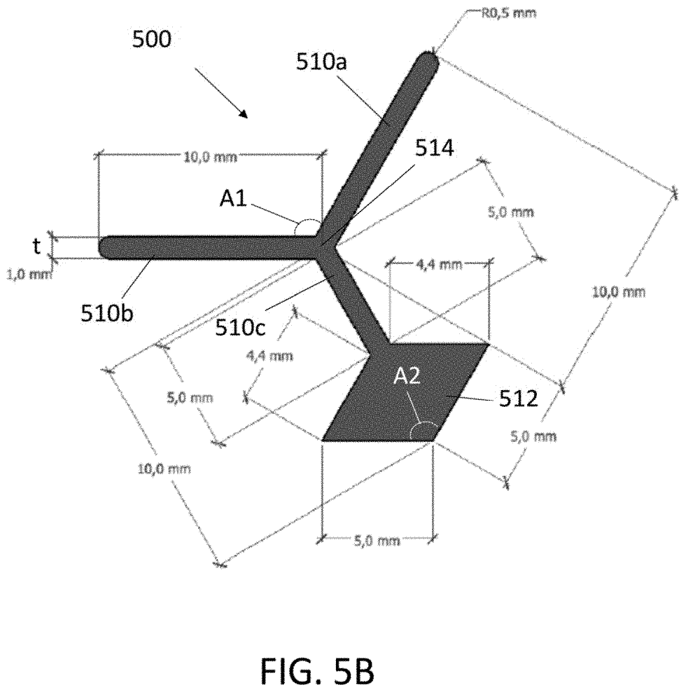

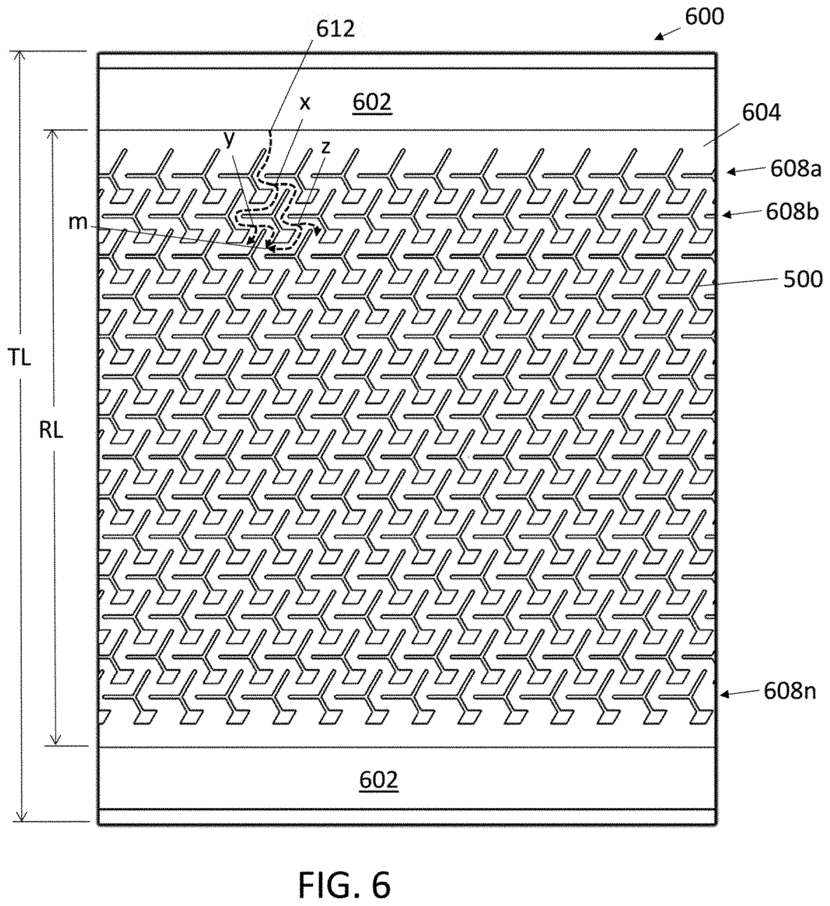

FIGS. 4-6 illustrate a variation on the pattern depicted in FIGS. 1 and 2. Pattern 400 generally depicted in FIG. 4 comprises a plurality of perforations 500 each having three prongs radially extending from a center point 514, with two prongs 510a, 510b having a relatively even thickness (t), and a third prong 510c having a bulbous end 512. As depicted in in FIG. 5B, perforations 500 are arranged in alternating rows 502a, 502b, 502c, 502d, etc. and staggered, such that corresponding center points (e.g. 514b, 514d) of perforations in alternating rows (e.g. 502b, 502d) are vertically aligned, with the prongs (e.g. 510c1, 510c2) and bulbous ends (e.g. 512b1, 512b2) of perforations in adjacent rows (e.g. 502b, 502c) intermeshed with one another. In the geometry depicted, prongs 510a and 510b form an included angle A1 of 120 degrees, which angle is matched by the external angle A2 of bulbous portion 512. The is perforations creates a path 612, with various branches, and multiple turns of more than 90 degrees, in which the overall distribution of electrons moving in the pathways may be more balanced than for path 50 associated with the pattern depicted in FIG. 2.

For example, although both paths 50 and 612 branch at multiple points, the subpaths within path 612 connecting points x, z, m and points x, y, m are relatively close in length as compared to any alternative pathways to the primary path 50 as depicted in FIG. 2. While the primary path 50 in FIG. 2 has branches off to the right s and left, electrons moving via each branch must traverse a substantial horizontal distance before joining another electron path moving vertically downward. Accordingly, electron flow across these horizontal pathways may be of, lesser magnitude than in the primary path that traverses from one end to the other in a generally vertical path.

o Additionally, because the manner in which the prongs and bulbous end intermesh with one another, the gap between the perforations is relatively constant along path 612, as is further illustrated by arrows a-j in FIG. 5A. This permits a more smooth flow of electrons in the current when a voltage is applied, resulting in a more uniform heat distribution in the heater. The bulbous end also provides slightly greater as 3D flexibility and stretchability for the heating element as compared to the 3 prong shape without the bulbous end on one prong. The bulbous shape also increases the open area as compared to designs without the bulbous shape. Although exemplary dimensions are provided in FIGS. 5A, 5B, perforations having the general geometric shape of perforation 500 (with three prongs emanating from a centerpoint at 120 degree angles relative to one another, with one prong having a bulbous, diamond-shaped end), the invention is not limited to any particular set of dimensions or spacing between perforations. Each of the dimensions shown, however, embodies a set of geometric ratios that may be present in preferred embodiments.

Flexibility, stretchability, and heat uniformity are preferred for applications for heating seats (e.g. vehicle seats), mattresses, clothing, and the like. In such non-limiting applications, perforation patterns that provide sufficient open area (preferably between 20-40%) and that maintain a relatively constant gap around adjacent perforation shapes for the current to flow with minimal interruption minimizes hot spots, are preferred.

In general, perforation geometries that have the same shortest distance between one perforation and the next along the full edge of the perforation optimize smoothest electron flow. Geometries that permit modification of the total length the charge has to travel between busbars by using size, and spacing of the perforations to achieve tailored resistance also have advantages. Such geometries are not limited to those depicted in FIGS. 4-6, however.

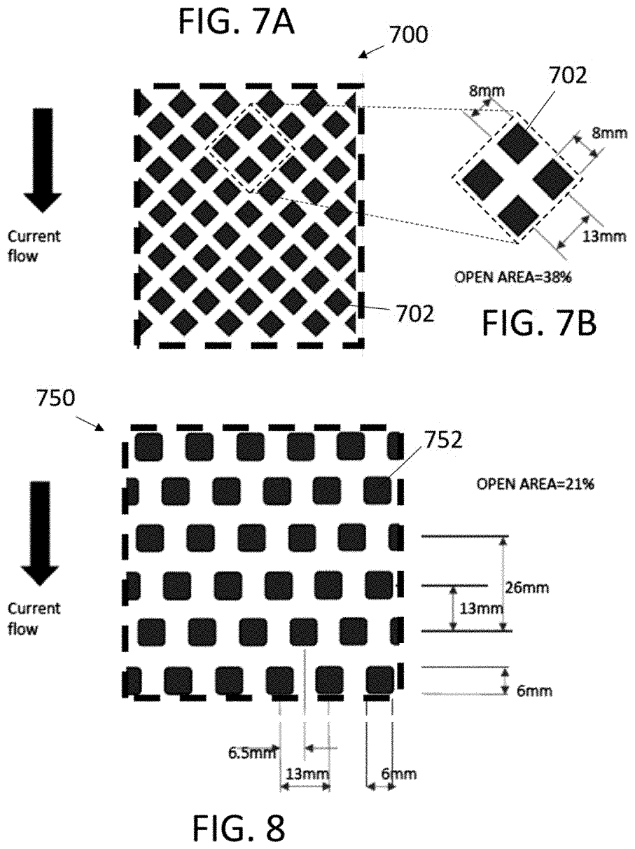

As shown in FIGS. 7A and 7, a geometric perforation shape generally in the s shape of a diamond may optimize smooth electron flow by having the same distance between adjacent perforations, as well as a same distance for branching pathways around each perforation. The size of the diamonds can be modified to provide for a desired percentage of open area. For example, diamonds having the dimensions, and spacing shown in FIG. 7B provide an open area of 38%. It should be understood that the dimensions of the perforations and the spacing can be changed to arrive at other percentage open areas, as desired. In the configuration depicted in FIG. 7C, the perforations have a generally square configuration, with the perforations in alternating rows offset from one another. The size and spacing as shown provides for an open area of 21%, but it should be understood that size and spacing may be modified to as tailor the heater to a desired open area percentage.

Although the perforations depicted in FIGS. 7A, 7B, and 7C have a regular 4-sided polygonal geometry, it should be understood that polygonals that are irregular and/or that have any number of sides may be used, including without limitation, triangular, pentagonal, and hexagonal shapes. Furthermore, although depicted with polygons of all the same size, arrangements with multiple sizes and mixtures of polygons may also be provided. Finally, the polygons depicted in FIG. 7C have rounder vertices rather than straight angled vertices as depicted in FIGS. 7A and 7B. It should be therefore understood that the “polygonal” shapes (and any of the geometries as referred to herein may have one or more vertices that are relatively rounded, without any limitation as to the radii used in such vertices. Thus, the three prong perforation shapes depicted in FIGS. 1 and 2 may be described having a generally polygonal geometry, comprising irregular 9-sided polygons in which each prong comprises 3 sides (2 long sides, and 1 short side), wherein each of the vertices at which the short side meets with a long side are rounded with a radius half the length of the short side, such that all of the short sides are replaced with half-circles. The term “generally polygonal” as used herein refers to a geometries that are “pure” polygons (having no rounded vertices) and geometries in which one or more of the vertices are rounded. In accordance with this definition, the 3-prong geometry with the bulbous, diamond shape replacing the short side, on one prong, adds 3 sides to the 3-prong shape, thereby forming a generally polygonal shape having 12-sides.

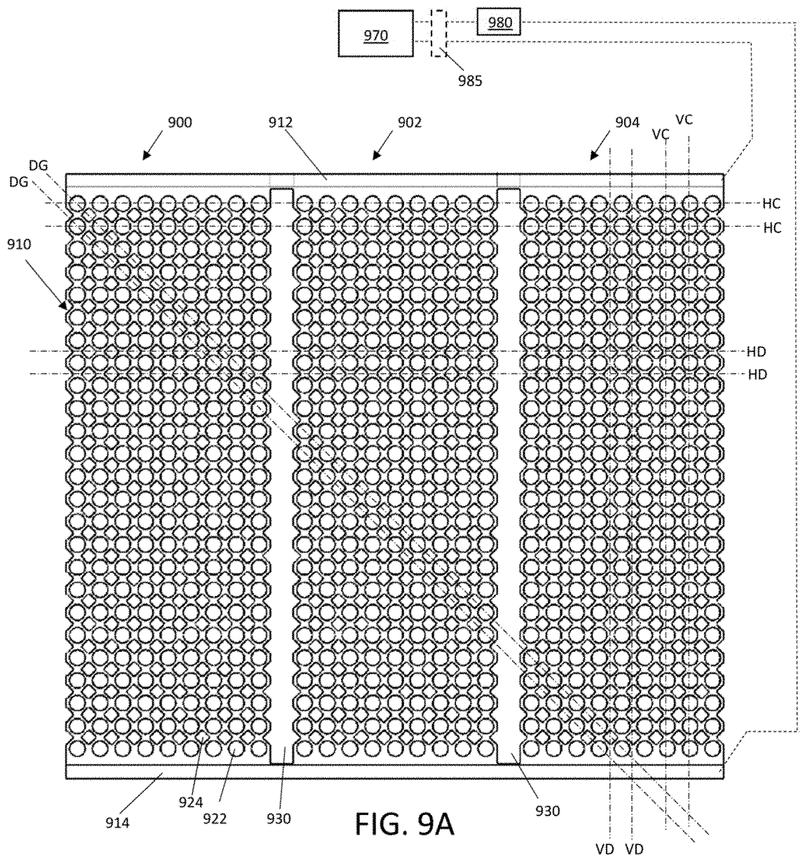

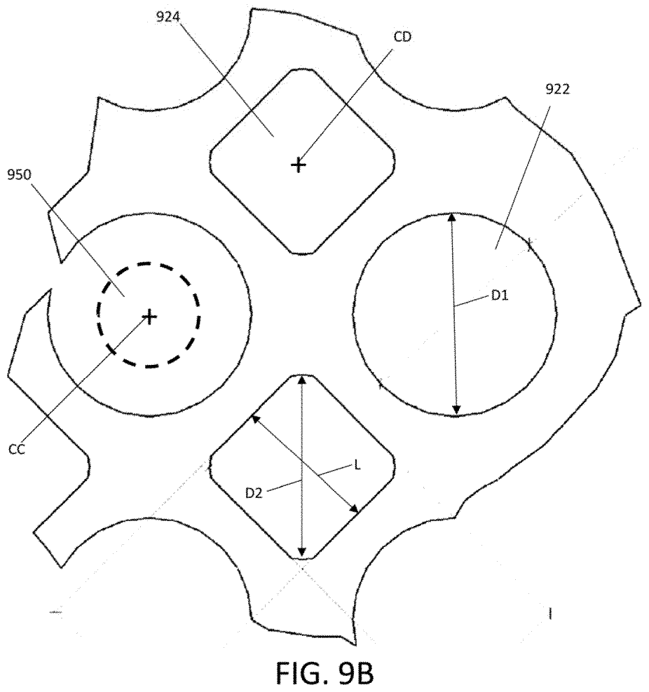

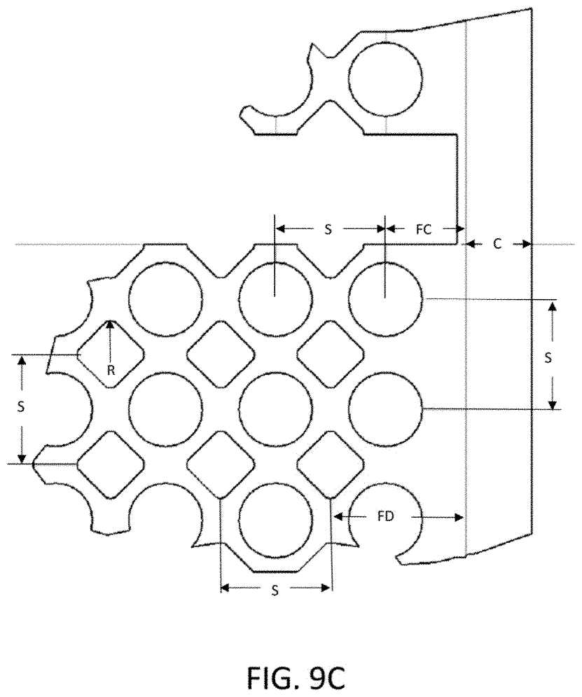

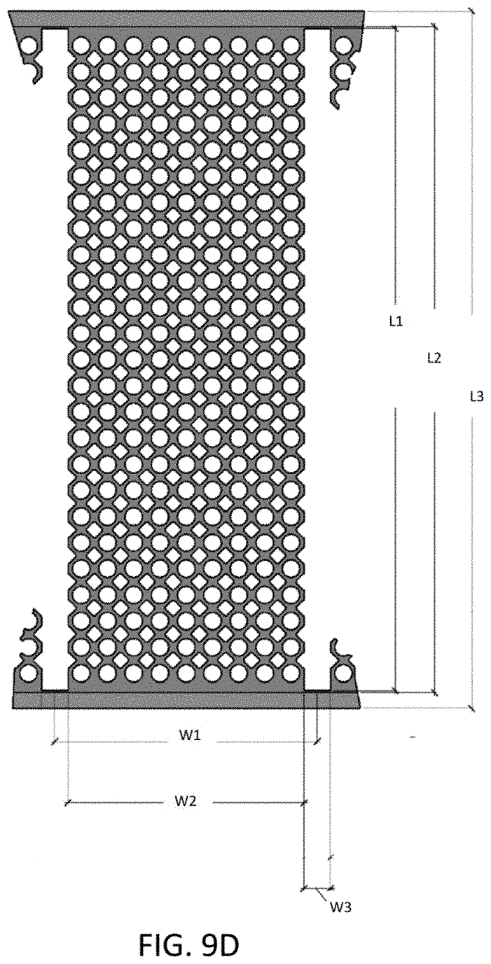

As best depicted in FIG. 9A, a plurality of parallel heating element units may be disposed in a repeating pattern with gaps or “cut lines” therebetween. For example, FIG. 9A shows three heating element units 900, 902, 904 in parallel, with gaps 930 between adjacent units, and the conductive strips extending across all of the units. It should be understood that more or fewer such elements may be provided, and that, the heating element may be manufactured in a roll comprising, a plurality of such heating element units in parallel. Such a roll may then be cut to a length having a desired number of heating element units, by cutting the units apart.

Each heating element comprises a core layer 910, such as a non-woven fiber layer comprising conductive (e.g. carbon) fibers, and at least two conductive strips 912, 914 positioned on opposite ends of the core layer. The core layer 910 contains a is plurality of perforations, including in the example shown, circular perforations 922 and diamond-shaped perforations 924 in a staggered relationship, as described above. The conductive strips 912, 914 extend across all of the parallel units 900, 902, 904. Between each heating element unit is disposed a gap 930 that extends from the innermost edges of the opposite conductive strips.

Although not limited to any particular dimensions, as best shown in FIG. 9D, length L3 from end to end of each heating element unit may be in the range of 2000 mm to 100 mm, more preferably 900 to 600, and in the embodiment depicted, 900 mm+−5 mm. The dimension L2 between the inner edges of the conductive strips may be in the range of 1950 to 70, more preferably 850 to 550, and in the embodiment depicted, 850 mm+/−5 mm. Thus, in the embodiment depicted, the width C of the conductive strip may be in the range of 10 to 30, more preferably 20 to 25, and in the embodiment depicted, 20 mm+/−1 mm. Length L1 of gap 930, may be in the range of 1950 mm to 50 mm, more preferably 830 mm to 70 mm, and in the embodiment depicted, 835 mm+/−2 mm, Thus, in the embodiment depicted, the distance between the inner edge of the conductive strip and the outermost edge of the gap is approximately 5 mm. The width W3 of the gap may be in the range of 10 mm to 40, more preferably 25 to 30, and in the embodiment depicted, 30 mm+/−0.5 mm. The width W2 of each heating element unit may be in the range of 150 to 400, more preferably 250 to 350, and in the embodiment depicted, 297 mm+/−1 mm, with the gaps spaced on-center in the range of 100 mm to 500, more preferably 200 to 400, and in the embodiment depicted, 300 mm+/−1 mm.

Each heating element unit may have a perforation pattern comprised of a mix of geometries, such as a mix of circular 922 and diamond-shaped geometries 924. As shown in FIG. 96, the diamond shapes may have rounded vertices and may be relatively smaller in size than the circular perforations. The mixed shapes may be disposed in staggered rows/columns, with the centers of the diamond shapes DC equidistantly interposed between the centers of adjacent circular shapes CC (and vice versa), with the diagonal dimension of the diamond D2 and the diameter of the circle D1 in a parallel direction overlapping one another. Although not limited to any particular dimensions, in the embodiment depicted, the circles have a diameter D1 22 mm+/−0.1 mm and the length of the edges of the diamonds of L=15.6 mm+/−0.1 with rounded vertices having a radius R of, e.g., 10 mm+/−0.1, ignoring the portion of the area subtracted by the rounded vertices (which result in a generally greater ratio), the ratio of the area of the circle to that of the diamond (π1²/4 L²) is approximately 1.56. Embodiments may have such a ratio ranging from 0.4 to 6.0, and more preferably 1 to 2. The absolute and relative dimensions and geometries may vary, however, from design-to-design, and may include a nearly infinite variety of patterns with relatively similar functional advantages within desired tolerances, but widely different ornamental aesthetics. The embodiment depicted is merely one embodiment of myriad possibilities with acceptable performance characteristics, and also considered to have aesthetic favorability.

As depicted in FIG. 9C, the mix of circular perforations may be spaced apart from adjacent perpendicular circular perforations in the column direction and in the row direction by the same distance S, which may be in a range of 15 to 40, and more preferably 25 to 35, and in the embodiment shown 33 mm+/−0.1 mm. Likewise, the diamond-shaped perforations may also be spaced apart from adjacent perpendicular perforations in the column direction and in the row direction by the same distance S as the circular perforations. Thus, the perforation pattern may be defined as a pattern comprising a first array of rows and columns of circular perforations equidistantly spaced, and a second array of rows and columns of diamond-shaped perforations equidistantly spaced by the same dimension as the spacing between, the circular perforations, with the second array intermeshed with the first array so that each diamond shaped perforation disposed among four circular perforations is equidistantly s spaced from all four circular perforations. The pattern may also be defined as a first array of diamond shaped perforations having opposite vertices arranged in a grid defined by columns disposed along a first set of parallel lines VD perpendicular to the electrically conductive busbars 912, 914 and rows HD disposed along a second set of parallel lines perpendicular to the first set of parallel lines, with the second array defined by centers of the plurality of circular perforations arranged in a grid defined by a third set of parallel lines VC perpendicular to the electrically conductive busbars and a fourth set of parallel lines HC perpendicular to the third set of parallel lines, with the first array and the second array disposed relative to each other with the first lines VC and third lines VD parallel to one another, the second lines HD and fourth lines HC is parallel to one another, and centers of the circular perforations alternating with diamond-shaped perforations arranged along a set of diagonal parallel lines DG.

In the embodiment depicted in FIG. 9C, the gaps 930 sever adjacent columns of diamond-shaped perforations through the centerlines of the diamond-shaped perforations, and thus the gap width W3 is equal to the spacing dimension S (within the defined tolerances). As depicted, the array of circular perforations extends from end-to-end such that the first row of perforations adjacent each conductive strip is a row of circular perforations. The diamond-shaped perforations fill the gaps among the circular perforations. The distance FC between the centerline of the first row of circular perforations and the innermost edge of each conductive strip may be in the range of 13 to 25, more preferably 16 to 25, and in the embodiment depicted, 24 mm+/−0.1 mm. The distance FD between the centerline of the first row of diamond-shaped perforations and the innermost edge of each conductive strip may be in the range of 30 to 50, more preferably 35 to 40, and in the embodiment depicted 40.5 mm+/−0.1 mm.

### Grounding Plane Layer

For high voltage applications (50 VAc plus), it may be desirable to provide additional safety features as, part of any finished laminar heater, to protect consumers against electric shocks or injuries when in use. Additionally, designs that maximize uniformity of temperature distribution are also desired to maximise efficiencies of operation.

For domestic heating, the use of supply voltage at 120-240 Vac may be s preferred in some installations, as using a low voltage supply typically entails inclusion of an additional transformer between the power supply and the connections to the heater. Transformers add cost and equipment in to the installation, which may have space or visibility disadvantages for certain installations. Also, power cables for lower voltage installations may demand a higher current rating, also adding cost to the overall installation.

Perforation patterns designed to create high resistance for high voltage applications may have relatively greater open areas than for lower voltage applications, such as, for example but without limitation, open area percentages in the range of up of to 50%, such as in the exemplary embodiment depicted in FIGS. 9A-9D. Larger open area percentages tends to create relatively high temperature differences between the conductive area of the heating element (e.g. the carbon fiber web) and the non-conductive areas of the perforations. For example, when the heater depicted in FIG. 9A-9D is powered at 230/240 Vac with an energy density of 250 W/m2 to achieve a temperature of approximately 47 C, a difference of minus 3-4 deg C may arise between the heated areas of the heating element and the insulated areas in the heater. Likewise, a temperature difference of up to minus 8-10 deg C in the gap 930 between discrete heating element units (e.g. 900, 902) may arise under similar conditions.

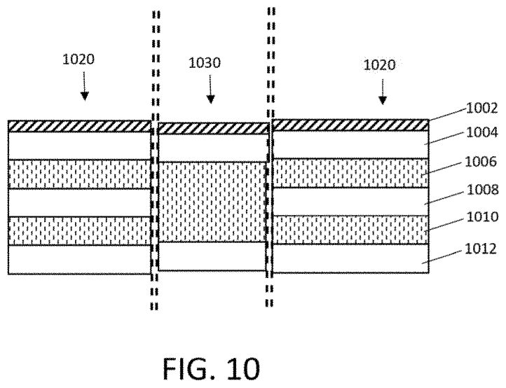

The composite laminar heater depicted in FIG. 10 is configured to minimize such temperature differences while also providing safety features for high voltage operation. As depicted in FIG. 10, layer 1004 comprises a woven glass fabric coated with a metal (preferably aluminum) layer 1002. The metal surface of layer 1002 provides a highly conductive path for discharging large currents, and also acts as grounding plane. FIG. 10 depicts an exemplary multi-ply composite, in which layers 1002 and 1004 may be provided as a composite that form a single ply, layer 1008 may be provided as a ply comprising a heating element having any of the designs as described hereinabove (and includes the conductive strips, not shown in the section depicted), and layer 1012 may be provided as a ply comprising another woven glass fiber layer. Layers 1006 and 1010 are laminating layers, preferably comprising glycol modified polyethylene terephthalate (PETG). The laminating layers may comprise any non-conductive material known in the art, however, capable of laminating the layers together using any lamination technology known in the art and suitable for the subject materials and specifications of use. FIG. 10 shows a perforated region 1030 disposed between non-perforated regions 1020, with dashed lines separating the regions. Gradient regions between perforated and non-perforated regions are not shown. Neither the relative dimensions of perforated and non-perforated regions nor the relative thicknesses of the layers, or composites thereof, are shown to scale.

As shown in FIG. 10, after a lamination step, the laminating layers 1006, 1010 together form a contiguous region 1007 of insulating material in each perforated region 1030, such that the laminated heater has a first cross-sectional composition in the perforated regions 1030, and a second cross-sectional composition in the non-perforated regions 1020. Although the contiguous region 1007 is depicted with a defined separation between layers 1006 and 1010, such a separation may be present. As depicted in FIG. 10, but not to scale, regions 1020, 1030 may have a relatively greater thickness between the outer surfaces of layers and 1012 in the region 1020 than in region 1030, due to the missing layer in region 1030. In some embodiments, these differences in thickness may be visibly apparent in relief from the outer surfaces of the laminar heater.

The thickness of layer 1002 may be tailored to provide sufficient heat capacity and thermal conductivity for distributing and conducting the heat flow evenly over the outer surface of the heater, such that a uniformity of heat distribution akin to that of laminar heaters comprised solely or primarily of highly-conductive metal. Thus, uniformity of heat distribution is improved relative to designs without the conductive metal layer, and adjacent areas between perforated areas and non-perforated areas of the heating element can be achieved within 1 deg C of each other. Likewise, the temperature differential in the cutting strips relative to the adjoining heater elements, may be significantly reduced, such as down to a 4-5 deg C differential from a 8-10 deg C differential, for the same design.

Although not limited to any particular dimensions, in exemplary embodiments, the woven glass fiber layers 1004, 1012 may have a density in the range of 60-300, more preferably, and most preferably 200 gsm+/−10 gsm. The metal layer 1002 may be a coating, such as aluminum, with a thickness in the range of 7 micron, more preferably 50 micron, and most preferably 40 micron+/−2 micron. The laminating layers may comprise, for example, PETG films having a thickness in the range of 100 to 300 micron, more preferably 150 to 250 micron, and most preferably 200 micron+/−10 micron. In preferred implementations, the layer 1012 is disposed as an inner surface (e.g. facing a surface to be heated, such as a wall, floor, etc.) and metal layer 1002 is disposed as an outer layer of the composite heating element. Laminar heater element layer may have a thickness in the range of 0.15 mm to 2 mm. In preferred embodiments, the total thickness of the laminar heater composite may be in the range of 0.5 mm to 0.6 mm. Metal layer 1002 may be disposed on the outer layer by any means known in the art, including vapor deposition process, coating or printing is processes, or adhesive processes using adhesives suitable for the temperatures experienced by the composite.

The composite laminate heater as described herein may be used in applications in which it is desirable to attach the composite laminate heater to a surface (such as a floor, wall, etc.), in which case fasteners (e.g. nails, screws, posts) may be used for fastening. As depicted in FIG. 9B, such a fastener (e.g. having a diameter of approximately 10 mm may be aligned to perforate the composite within the circular perforation (thus not perforating the electrically conductive portion of the heating element itself, only the other layers of the composite disposed in the perforation). Because the metal layer is connected to ground, if a conductive object were to inadvertently puncture the conductive portion of the heating element embedded within the composite laminate, the metal layer would carry current from the puncturing conductive object through the metal layer to ground, rather than the electricity being conducted to a person via the conductive puncturing object, directly (e.g. from touching the conductive puncturing object) or indirectly (e.g. from standing in water in contact with the conductive puncturing object). This provides desirable safety benefits for high-voltage applications (e.g. 110-240 VAc), such as when the conductive strips of the heating element (e.g. 900, 902, 904) are connected to a high voltage power source 970 without a voltage-reducing transformer interposed between the power source and the conductive strips. Of course, a controller 980 may still be interposed between the power source and the conductive strips, to control the amount of power supplied to control the heat produced. Other embodiments with an optional transformer 975 may also be provided.

The composite heater may be manufactured in rolls comprising parallel heating element units, severable at the gaps between adjacent units, and then attached to a surface using fasteners that penetrate the heating units through the circular perforations. Although the perforations and gaps are disposed between the other p es of the composite, as described herein, the outlines of the perforations and gaps are perceptible through the other layers because of differences in thickness in the composite between areas in which the heating element is present, and areas in which the heating element is perforated or absent because of a gap. In some embodiments, printed cut lines or fastener affixation zones may be printed on the outside layer of the composite heater, in register with the holes and gaps within a desired degree of tolerance.

Laminar heating elements having perforation geometries as shown and claimed herein have functional advantages over heating elements with different perforations geometries, particularly perforation geometries of the prior art, as discussed herein. While perforation pattern designs having claimed features may have functional advantages over prior art designs lacking such claimed features, the relative differences in the functional advantages may vary from design to design, and all or most may have relatively similar production costs. Accordingly, final selection of a design may be driven equally or more by aesthetics, as some designs may be more aesthetically pleasing than others and thus may be favored purely for that reason, particularly. Although the heating element may be, embedded at the center of multiple plies, the finished product may still feature the perforation geometry in relief or printed in register. Because different design elements may be varied and selected while maintaining functionality, a variety of ornamental configurations may be available with substantially the same function or performance. As non-limiting examples, the exact contours of perforations geometries, such as relative size, overall geometry, blend of multiple geometry, spacing, intermeshing, and overall size and shapes of the heating element units, may be varied to provide different ornamental appearances while maintaining substantially similar functionality. Likewise, the disposition of multiple laminar heater element units relative to one another, and the relative sizes and proportions of the conductive strips in the context of a series of parallel laminar heater element units may have any relationship with one another, with similar functionality, other than the embodiment depicted in FIG. 9A, which represents a single embodiment conforming to a particular ornamental design. The laminar heater unit design as depicted may feature the perforation pattern as depicted, or may feature a different perforation pattern. One or more specific ornamental designs of the heating element layer may be protected separately in one au or more design patent applications.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A laminar heater comprising an electrically conductive laminar heating element comprising a pair of electrically conductive busbars disposed adjacent opposite ends of the heating element, the laminar heating element having at least a first area with a first plurality of perforations, wherein the first plurality of perforations have a generally polygonal geometry.

2. The laminar heater of claim 1, wherein the generally polygonal geometry comprises one or more rounded vertices.

3. The laminar heater of claim 1, wherein the generally polygonal geometry comprises a 4-sided polygon.

4. The laminar heater of claim 2, wherein the generally polygonal geometry comprises an irregular polygon having three prongs extending along at least three co-planar axes from an intersection point of the axes, each prong having at least 3 sides.

5. The heater of claim 4, wherein two of the three prongs have an equal width for a full length of the prong, as defined by two parallel relatively longer sides that form vertices with a relatively shorter side, and one prong comprises two parallel sides that extend less than a full length of the prong and that diverge into a bulbous end.

6. The laminar heater of claim 5, wherein the bulbous end has a diamond shape.

7. The laminar heater of claim 1, wherein the laminar heater is conformable into a non-planar shape with a predetermined degree of flexibility that is relatively greater than an otherwise equivalent heater having slit-shaped perforations aligned in parallel rows.

8. The laminar heater of claim 1, comprising a branching electron path between adjacent perforations including a diversion where the path splits into at least two paths and a convergence where at least two paths come together in a single path.

9. The laminar heater of claim 1, further comprising at least a second area having a second plurality of perforations, wherein each of the second plurality o perforations is different than each of the first plurality of perforations with respect to at least one perforation characteristic.

10. The laminar heater of claim 1, further comprising a second plurality of perforations intermeshed with the first plurality of perforations.

11. The laminar heater of claim 1, wherein the first plurality of perforations has a diamond shape, and the second plurality of perforations has a circular shape.

12. The laminar heater of claim 11, wherein the geometry of the diamond shape includes rounded vertices.

13. The laminar heater of claim 11, wherein the first plurality pf perforations is disposed in an array having a spacing distance D on-center in two perpendicular directions.

14. The laminar heater of claim 13, wherein the second plurality of as perforations is disposed in an array having a spacing distance D on-center in two perpendicular directions.

15. The laminar heater of claim 14, wherein the second array is intermeshed with the first array so that each perforation of the first array disposed among four adjacent perforations of the second array is equidistantly spaced from all four or the adjacent perforations in the second array.

16. The laminar heater of claim 1, wherein the laminar heating element is disposed in a composite of plies, including at least two non-metal layers in contact with the heating element, and a metal layer disposed on an outer surface of the composite.

17. The laminar heater of claim 16, wherein the heating element is disposed between two glass fabric layers, wherein the metal layer is disposed on an outer surface of one of the glass fabric layers.

18. The laminar heater of claim 17, further comprising a laminating layer disposed between the laminar heating element and each glass fabric layer.

19. The laminar heater of claim 18, wherein adjacent laminating layer plies define a contiguous insulated area disposed in each of the perforations of the laminar heating element ply.

20. The laminar heater of claim 16, comprising a plurality of laminar heating element units each having a length from a first unit edge to a second unit edge, and a width arranged in parallel along their respective lengths, with parallel gaps between adjacent units extending for a majority of the length of the adjacent units from a first gap length edge to a second gap length edge, and the conductive strips extending across the plurality of the heating element units, including connecting portions between adjacent units in first and second connecting regions respectively disposed between the first gap edge and the first unit edge, and between the second gap edge and the second unit edge.

21. A method for installing the laminar heater of claim 20, comprising providing a sheet or roll comprising a relatively larger number of laminar heating element units, cutting from the sheet or roll an installation portion having a desired relatively smaller number of laminar heating element units by severing the sheet or roll between a set of adjacent units through a cut line extending through the first and second connecting regions between the adjacent units.

22. The method of claim 21, further comprising securing the installation portion to a surface with a plurality of fasteners, including one or more fasteners disposed with a fastening portion penetrating the installation portion through one of the perforations.

23. A heating system comprising at least one laminar heater of claim 16 disposed on a surface for providing heat to the surface, wherein the conductive strips are connected to a power source having a nominal voltage in a range of 110-240 VAc, without a transformer interposed between the power source and the conductive strips.

24. The heating system of claim 23, further comprising a controller interposed between the power source and the conductive strips.
